(19) United States
(12) Patent Application Publication
(10) Pub. No.: US 2012/0249041 A1
(43) Pub. Date: Oct. 4, 2012

(54) SERVO CONTROL APPARATUS

(75) Inventor: Hirohisa Kuramoto, Minato-ku (JP)

(73) Assignee: MITSUBISHI HEAVY INDUSTRIES, LTD., Tokyo (JP)

(21) Appl. No.: 13/501,223

(22) PCT Filed: Sep. 9, 2010
(86) PCT No.: PCT/JP2010/065464

§ 371 Date: Jun. 22, 2012

(30) Foreign Application Priority Data
Dec. 24, 2009 (JP) 2009-291904

(51) Int. Cl. G05B 13/02

(52) U.S. Cl. 318/561

(57) ABSTRACT

A control unit performs servo control of a table, which is a load, by performing feedback control of a servomotor. An inverse characteristic model performs feedforward compensation control by obtaining a speed compensation signal that compensates for the dynamic errors of a mechanical system. When the rigidity of a screw section of a ball screw along the axial direction changes, a rigidity-change compensation unit changes the rigidity value of the screw section along the axial direction that is included in the compensation control transfer functions of the inverse characteristic model, in accordance with the change in rigidity. Thus, the servo control apparatus compensates for such changes in rigidity and performs accurate servo control of the position of the table, even when the ball screw of a feeding mechanism expands or contracts due to secular change or change in temperature, and rigidity along the axial direction changes.

### TECHNICAL FIELD

This invention relates to a servo control apparatus which is designed to be capable of exercising accurate servo control of the position of a load even when a ball screw of a feeding mechanism expands or contracts due to a secular change or a change in temperature, thereby changing the rigidity of the ball screw.

### BACKGROUND ART

Among industrial machines is one in which a servo control apparatus performs servo control of the position and speed of the load. With such an industrial machine, the rotational movement of a servomotor is converted into a linear movement by a ball screw to move the load linearly.

<Configuration of Industrial Machine>

A typical example of such an industrial machine is a machine tool.

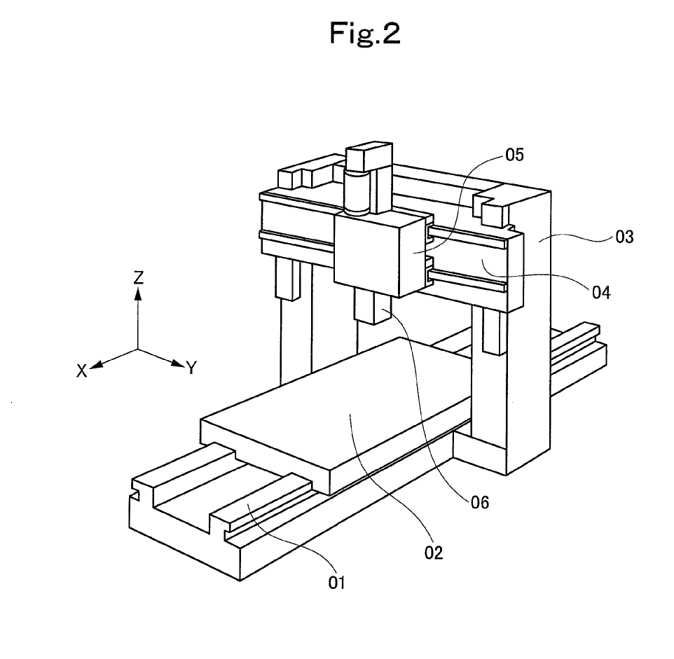

An example of the machine tool is explained based on FIG. 2. As shown in this drawing, a table 02 is disposed on a bed 01, and the table 02 is provided to be movable in an X direction on the bed 01.

On a gate-shaped column 03, a cross rail 04 is disposed to be ascendable and descendable (movable along a Z direction). On the cross rail 04, a saddle 05 with a ram 06 is provided to be movable along a Y direction.

The movement in the X direction of the table 02, which is a load, is made by a feeding mechanism. The movement in the Y direction of the saddle 05, which is a load, is also made by another feeding mechanism installed on the cross rail 04. In this case, the positions and moving speeds of the table 02 and the saddle 05 are required to be controlled with high accuracy.

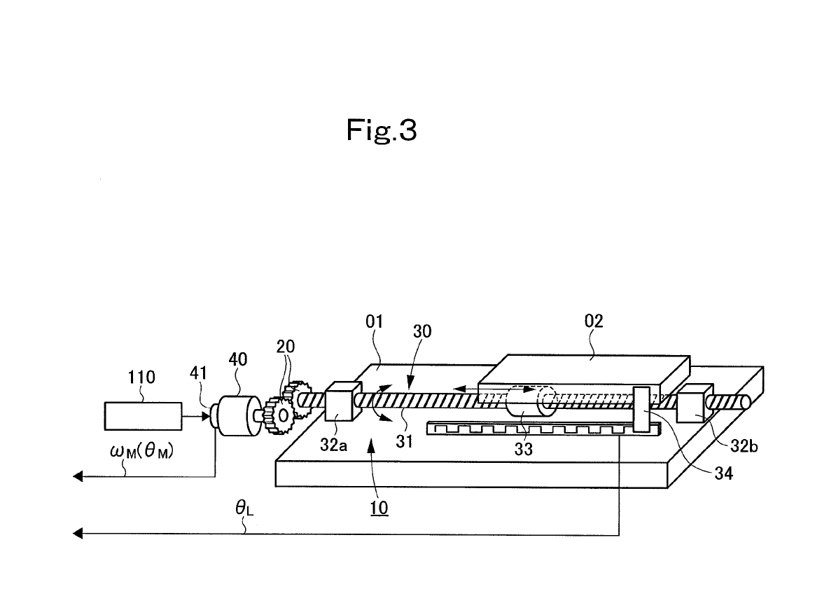

A feeding mechanism 10 for driving the table 02, and a device configuration in its surroundings will be described by reference to FIG. 3.

The feeding mechanism 10 is composed of a speed reducer 20 comprising gears, and a ball screw 30, as main members. In FIG. 3, the speed reducer 20 is illustrated in a simplified form.

A screw section 31 of the ball screw 30 has its base end side (left end side in FIG. 3) supported rotatably by a rotating support bracket 32a, and has its leading end side (right end side in FIG. 3) supported rotatably by a rotating support bracket 32b. The rotating support brackets 32a, 32b are each composed of a bearing and a bracket, and are arranged on the bed 01 away from each other. Of them, the rotating support bracket 32b is disposed to pull the screw section 31 toward the base end (rightward in FIG. 3), thereby exerting a tensile force on the screw section 31.

A nut section 33 of the ball screw 30 is screwed to the screw section 31, and coupled to the table 02.

The rotational movement of a servomotor 40 is converted into a linear movement by the ball screw 30 of the feeding mechanism 10.

That is, when the servomotor 40 rotates, its rotating force is transmitted to the screw section 31 via the speed reducer 20, whereby the screw section 31 rotates. When the screw section 31 rotates, the nut section 33 linearly moves along the screw section 31, and the table 02 linearly moves in accordance with this linear movement of the nut section 33.

At this time, the rotational position of the servomotor 40 is detected by a pulse encoder 41 disposed on the servomotor 40. The pulse encoder 41 outputs a pulse signal each time the rotor of the servomotor 40 makes a rotation through a predetermined angle of rotation. Thus, the signal outputted from the pulse encoder 41 (pulse signal) becomes a motor position signal θ_{M} indicating the rotational position of the rotor of the servomotor 40, and also becomes a motor speed signal ω_{M} indicating the rotational speed of the servomotor 40.

The position of linear movement of the table 02 is detected by a position detector 34 such as a linear scale. The position detector 34 outputs a load position signal θ_{L} indicating the position of the table (load) 02.

<Explanation for Feedback Control>

To effect the position control of the table 02 in the mechanism as shown in FIG. 3, feedback control according to a classical theory of control is generally used.

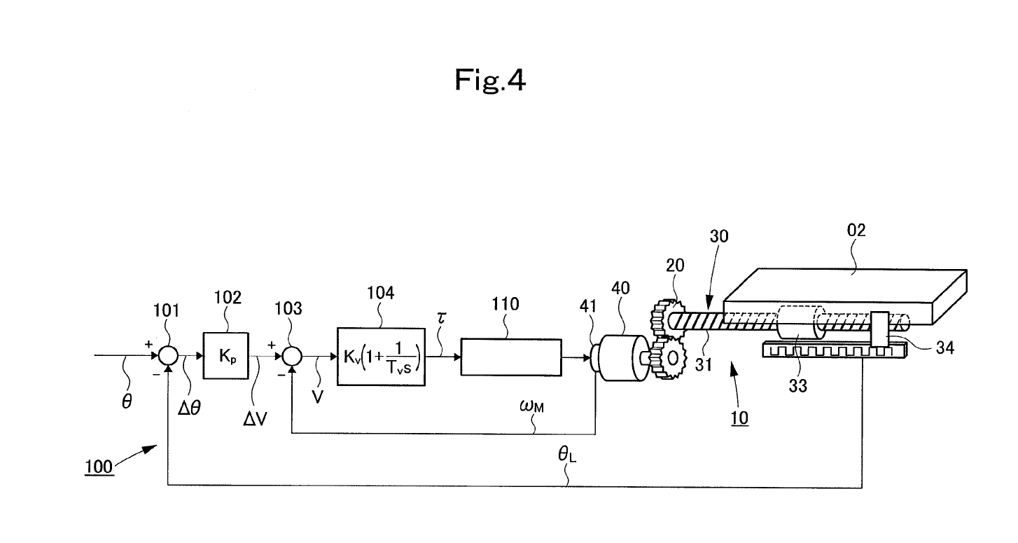

The technique of this feedback control will be described with reference to FIG. 4.

As shown in FIG. 4, a control unit 100 has a subtracter 101, a multiplier 102, a subtracter 103, and a proportional plus integral computing unit 104.

The subtracter 101 outputs a position error signal Δθ which is the difference between a position command signal θ and the load position signal θ_{L}. The multiplier 102 multiplies the position error signal Δθ by a position loop gain Kₚ to output a speed error signal ΔV. The subtracter 103 outputs a speed command signal V which is the difference between the speed error signal ΔV and the motor speed signal ω_{M}.

The proportional plus integral computing unit 104 performs the proportional plus integral computation of the speed command signal V to output a torque command signal τ.

That is, the proportional plus integral computing unit 104 computes

τ=V×{Kᵥ(1+(1/Tᵥs))}

with the use of a speed loop gain Kᵥ and an integration time constant Tᵥ to obtain the torque command signal τ. The symbol s represents a Laplace operator (in the following explanations as well, “s” represents a Laplace operator).

A current control unit 110 supplies the servomotor 40 with an electric current which takes an electric current value corresponding to the torque command signal τ. As a result, the servomotor 40 is rotationally driven.

In this case, feedback control over the electric current is performed so that the electric current value conformed to the torque command signal τ is supplied, although an illustration for this is omitted.

As mentioned above, the control unit 100, which controls the servomotor 40 for driving the table 02, exercises feedback control in a triple loop mode, with the position loop as a main loop, and the speed loop and the current loop as minor loops.

FIG. 4 illustrates a control system for the feeding mechanism 10 which drives the table 02 along the X direction. The configuration of, and a control system for, the feeding mechanism for driving the saddle 05 along the Y direction also have the same features as those for the control system for the feeding mechanism 10.

With the feedback control as shown in FIG. 4, in response to a position instructed by the position command signal θ, the actual position of the table (load) 02 follows with a delay.

<Explanation for Feedforward Control>

The incorporation of feedforward control into feedback control is performed as a means of compensating for a control lag or delay which occurs in feedback control.

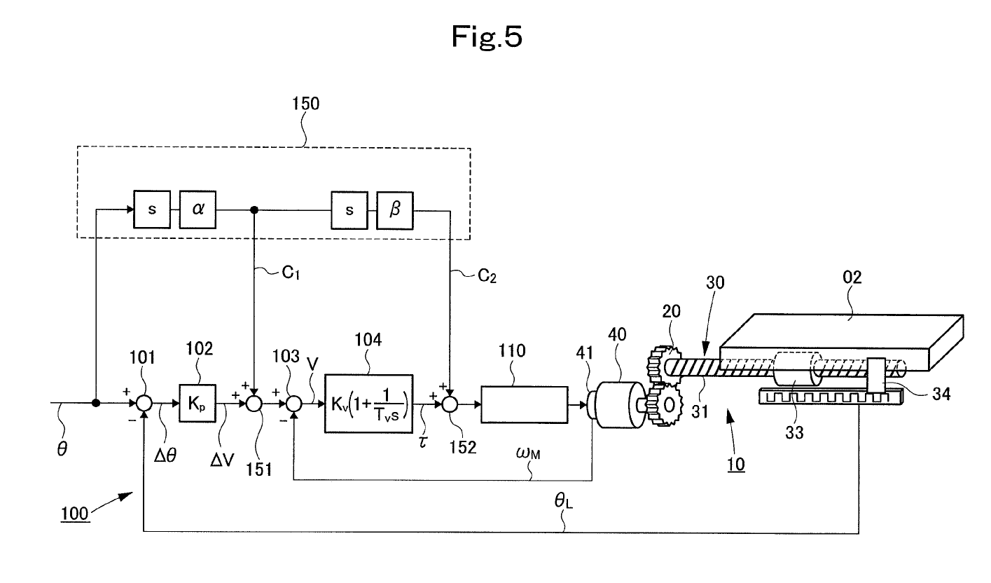

FIG. 5 shows a feedforward control unit 150 and adders 151, 152 incorporated into the feedback control circuit shown in FIG. 4.

The feedforward control unit 150 differentiates the position command signal θ, and multiply the resulting value by a position control loop delay compensation factor α to obtain a position delay compensation signal C₁. Further, the feedforward control unit 150 differentiates the position delay compensation signal C₁, and multiply the resulting value by a speed control loop delay compensation factor β to obtain a speed delay compensation signal C₂.

The adder 151 adds the position delay compensation signal C₁ to the speed error signal ΔV, and the adder 152 further adds the speed delay compensation signal C₂ to the torque command signal τ to perform feedforward control.

By so adding the position delay compensation signal C₁ to compensate for the position delay, and adding the speed delay compensation signal C₂ to compensate for the speed delay, the position delay and the speed delay occurring in the feedback control can be compensated for nearly completely.

Even when control comprising feedforward control added to feedback control is exercised, however, it is impossible to compensate for a delay or vibration due to dynamic deformation, such as deflection or torsion, of a machine element which is the controlled object.

To be more specific, the feeding mechanism 10 is composed of the speed reducer 20 and the ball screw 30. Since the rigidity of the ball screw 30 is limited, torsion or deflection occurs in the ball screw 30 during movement such as axial movement, presenting a cause of deterioration in machining accuracy.

<Explanation for Control Using Approximate Model for Controlled Object and Inverse Characteristic Model>

Proposals have been made for a technology to obtain an approximate model for a controlled object, also obtain an inverse characteristic model (compensation circuit) for the approximate model, and incorporate the inverse characteristic model (compensation circuit) into a control circuit, thereby compensating for a delay or vibration due to dynamic deformation, such as deflection or torsion, of a machine element as the controlled object (see, for example, Patent Documents 1 to 3).

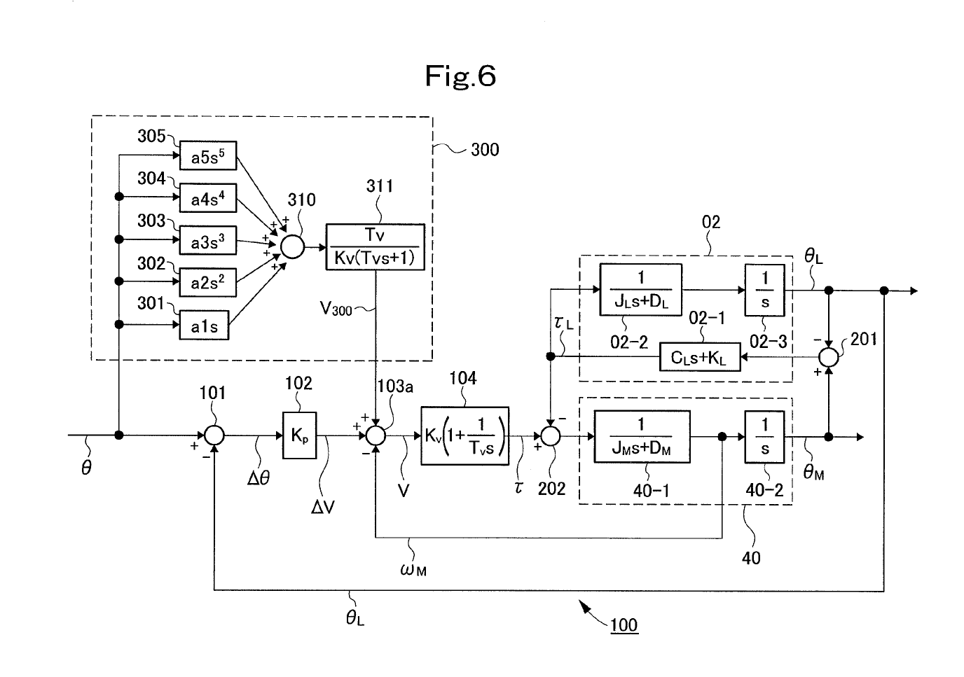

An example of a control technique having such an inverse characteristic model (compensation circuit) incorporated into a control unit (the technology shown in Patent Document 3) will be described by reference to FIG. 6. In FIG. 6, parts performing the same functions as those in FIG. 4 are assigned the same numerals as those in FIG. 4.

In the example shown in FIG. 6, a servomotor 40 and a table 02 as a load are used as material particles or material points or, simply, particles, and the characteristics of a mechanical system are specified as a model of a two-particle mechanical system involving these particles.

This mechanical system is subjected to servo control (feedback control) by a control unit 100, as basic control, and is also subjected to feedforward compensation control by an inverse characteristic model 300 during this process.

If the characteristics of the servomotor 40 are modeled and represented by transfer functions, they are expressed as a block 40-1 and a block 40-2, as shown in FIG. 6. The symbol J_{M} denotes motor inertia, and D_{M} denotes motor viscosity.

The block 40-1 outputs a motor speed signal ω_{M}, while the block 40-2 outputs a motor position signal θ_{M}.

If the characteristics of the table 02, which is the load, are modeled and represented by transfer functions, they are expressed as a block 02-1, a block 02-2 and a block 02-3.

The symbol J_{L} denotes the inertia of the load (table), D_{L} denotes the viscosity of the load (table), C_{L} denotes the spring viscosity along the axial direction of a ball screw 30 (screw section 31, support brackets 32a, 32b, nut section 33) of a feeding mechanism 10, and K_{L} denotes the spring rigidity along the axial direction of the ball screw 30 (screw section 31, support brackets 32a, 32b, nut section 33) of the feeding mechanism 10.

A subtracter 201 obtains a deviation between the motor position signal θ_{M} and a load position signal θ_{L} (θ_{M}-θ_{L}). Upon entry of the deviation (θ_{M}-θ_{L}) the block 02-1 outputs a reaction force torque signal τ_{L}.

When the reaction force torque signal τ_{L} is inputted to the block 02-2, the block 02-3 outputs the load position signal θ_{L}.

A subtracter 202 obtains a deviation between a torque command signal τ and the reaction force torque signal τ_{L}(τ-τ_{L}). This deviation (τ-τ_{L}) is inputted to the block 40-1.

The control unit 100 has a subtracter 101, a multiplier 102, a subtracter 103a, and a proportional plus integral computing unit 104.

The subtracter 101 outputs a position error signal Δθ which is the difference between a position command signal e and the load position signal θ_{L}. The multiplier 102 multiplies the position error signal Δθ by a position loop gain Kₚ to output a speed error signal ΔV.

The subtracter 103a adds a speed compensation signal V₃₀₀, which has been outputted from the inverse characteristic model 300, to the speed error signal ΔV, and subtracts the motor speed signal ω_{M} from the resulting sum, to output a speed command signal V.

Details of the speed compensation signal V₃₀₀ will be described later. By adding (for compensation) the speed compensation signal V₃₀₀, it becomes possible to compensate for sources of error occurring in the servomotor 40, feeding mechanism 10 or table (load) 02, such as “distortion”, “deflection” or “viscosity”, thereby performing the position control (servo control) of the table 02 accurately.

The proportional plus integral computing unit 104 performs the proportional plus integral computation of the speed command signal V to output a torque command signal τ.

The servomotor 40 is supplied with an electric current conformed to the torque command signal τ from a current controller (not shown in FIG. 6), whereby it is rotationally driven. In this case, feedback control over the electric current is performed so that an electric current value conformed to the torque command signal τ is obtained, although this is not shown.

As mentioned above, the control unit 100 exercises feedback control in a triple loop mode, with the position loop as a main loop, and the speed loop and the current loop as minor loops.

The inverse characteristic model 300 has a first-order derivative term computing unit 301, a second-order derivative term computing unit 302, a third-order derivative term computing unit 303, a fourth-order derivative term computing unit 304, a fifth-order derivative term computing unit 305, a summing unit 310, and a proportional plus integral inverse transfer function unit 311.

That is, compensation control transfer functions, which compensate for sources of error, are set in the inverse characteristic model 300 by computing equations established in the respective derivative term computing units 301 to 305, the summing unit 310, and the proportional plus integral inverse transfer function unit 311.

The compensation control transfer functions, adapted to perform compensation control for compensating for causes of dynamic error in the servomotor 40, sources of dynamic error in the feeding mechanism 10, and sources of dynamic error in the table 02 as the load to bring the position indicated by the load position signal θ_{L} into conformity with the position indicated by the position command signal θ, are set in the respective derivative term computing units 301 to 305 and the summing unit 310.

The compensation control transfer functions are inverse transfer functions which are the reverse of the transfer functions of the mechanical system composed of the servomotor 40, the feeding mechanism 10 and the table (load) 02. These inverse transfer functions are functions from which some arithmetic elements have been omitted.

Concretely, the first-order to fifth-order derivative term computing units 301 to 305 have operands a1s, a2s², a3s³, a4s⁴ and a5s⁵, respectively, and output arithmetic signals obtained by multiplying the position command signal θ by the respective operands. The symbol “s” represents a Laplace operator (differential operator).

In this case, the values of the coefficients a1 to a5 are set as indicated below, provided that

K_{V} is the speed loop gain,

K_{L} is the spring rigidity along the axial direction of the ball screw 30,

T_{V} is the integration time constant,

D_{M} is the viscosity of the servomotor 40,

D_{L} is the viscosity of the load (table 02),

J_{M} is the inertia of the servomotor 40, and

J_{L} is the inertia of the load (table 02).

$$a 1 = \frac{{K}_{V}}{{T}_{V}} \\ a 2 = {D}_{M} + {D}_{L} + {K}_{V} + \frac{{K}_{V} {D}_{L}}{{T}_{V} {K}_{L}} \\ a 3 = {J}_{M} + {J}_{L} + \frac{{D}_{M} {D}_{L} + {K}_{V} {D}_{L}}{{K}_{L}} + \frac{{K}_{V} {J}_{L}}{{T}_{V} {K}_{L}} \\ a 4 = \frac{{J}_{M} {D}_{L} + {J}_{L} {D}_{M} + {K}_{V} {J}_{L}}{{K}_{L}} \\ a 5 = \frac{{J}_{M} {J}_{L}}{{K}_{L}} \qquad [ Equation 1 ]$$

The proportional plus integral inverse transfer function unit 311 has, as its transfer function, {Tᵥ/Kᵥ(Tᵥₛ+1)} of {Tᵥ/Kᵥ(Tᵥₛ+1)}×s which is an inverse transfer function for Kᵥ(1+(1/Tᵥₛ)) being the transfer function of the proportional plus integral computing unit 104. The differential operator s is allocated to the respective coefficients a1 to a5.

The transfer function {Tᵥ/Kᵥ(Tᵥₛ+1) } set in the proportional plus integral inverse transfer function unit 311 is a fixed value (constant value) determined by the characteristics of the control system.

Control compensation using the above-mentioned inverse characteristic model 300 makes it possible to compensate for causes of dynamic error in the servomotor 40, sources of dynamic error in the feeding mechanism 10, and sources of dynamic error in the table 02 which is the load, thereby accurately performing the position control of the table 02.

### PRIOR ART DOCUMENTS

### Patent Documents

Patent Document 1: Japanese Patent No. 3351990

Patent Document 2: Japanese Patent No. 3739749

Patent Document 3: JP-A-2009-201169

### SUMMARY OF THE INVENTION

### Problems to be Solved by the Invention

With the conventional technology shown in FIG. 6 (Patent Document 3) or the technology of Patent Document 2, compensations have been made by the inverse characteristic model (compensation circuit), with the physical constants of the feeding system being set to have constant values. With Patent Document 1, compensations have been made using the rigidity value of the feeding system that has been measured beforehand according to the position of the machine (for example, the position of the table).

With the technologies of Patent Documents 1 to 3, therefore, there has been the problem that compensations with high accuracy cannot be made, if the ball screw 30 of the feeding mechanism 10 as the feeding system (i.e., screw section 31, support brackets 32a, 32b, nut section 33) expands or contracts owing to a secular change or temperature change, and a change in the rigidity of the ball screw 30 occurs.

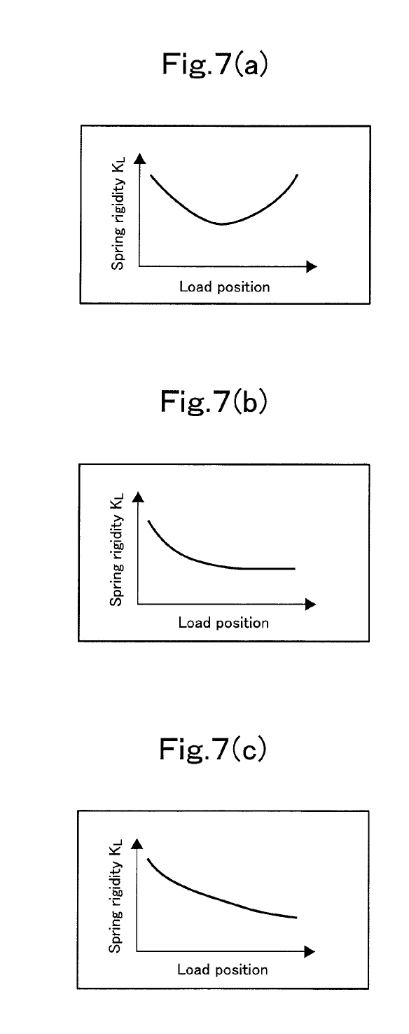

That is, if the expansion state of the screw section 31 changes because of a secular change or temperature change, the spring rigidity K_{L} along the axial direction of the ball screw 30 changes as shown in FIG. 7(a), FIG. 7(b) or FIG. 7(c).

In FIGS. 7(a), 7(b) and 7(c), the abscissa represents the load position (position of table 02 or nut section 33), and the left-hand side of the horizontal axis corresponds to the side where the rotating support bracket 32a is located, while the right-hand side of the horizontal axis corresponds to the side where the rotating support bracket 32b is located. The ordinate represents the spring rigidity K_{L}.

FIG. 7(a) shows the spring rigidity K_{L} conformed to the load position when the screw section 31 is reliably pulled by the support bracket 32a, and the screw section 31 is firmly supported by the support bracket 32a and the support bracket 32b (both ends are fixedly supported).

FIG. 7(b) shows the spring rigidity K_{L} conformed to the load position when the screw section 31 is somewhat expanded in the axial direction because of a temperature change or the like, and the screw section 31 is firmly supported by the support bracket 32a (fixedly supported at one end), but the support for it at the support bracket 32b slackens (semi-fixedly supported at the other end).

FIG. 7(c) shows the spring rigidity K_{L} conformed to the load position when the screw section 31 is greatly expanded in the axial direction because of a temperature change or the like, and the screw section 31 is firmly supported at the support bracket 32a (fixedly supported at one end), but the support for it at the support bracket 32b completely slackens (freed at the other end).

With the technologies of Patent Documents 1 to 3, no consideration is given to the spring rigidity K_{L} changing owing to a change in the supported state of the screw section 31 caused by the expansion or contraction of the screw section 31, as shown in FIG. 7(a), 7(b) or 7(c). Thus, highly accurate compensations cannot be made.

The present invention has been accomplished in the light of the above-described conventional technologies. It is an object of the invention to provide a servo control apparatus which, even when the ball screw of the feeding mechanism expands or contracts because of a secular change or temperature change and the rigidity along the axial direction of the ball screw changes, can compensate for such changes in rigidity and perform accurate servo control of the position of the load.

### Means for Solving the Problems

A constitution of the present invention for solving the above problems is a servo control apparatus for controlling an industrial machine in which a rotational movement of a servomotor is converted into a linear movement by a feeding mechanism, including a ball screw, to move a load linearly by the converted linear movement, comprising:

an inverse characteristic model having, set therein, compensating transfer functions which are inverse transfer functions as a reverse of transfer functions of a mechanical system composed of the servomotor, the feeding mechanism, and the load, wherein the inverse characteristic model outputs a compensation signal (V₃₀₀) for compensating for sources of dynamic error of the mechanical system when a position command signal (θ) indicating a command position of the load is inputted to the compensating transfer functions;

a control unit for performing feedback control so as to eliminate a position error signal (Δθ) which is a deviation between the position command signal (θ) and a load position signal (θ_{L}) indicating a position of the load, and to eliminate a deviation between a speed error signal (ΔV) proportional to the position error signal (Δθ) and a motor speed signal (ω_{M}) indicating a speed of the servomotor, and for further performing feedforward compensation control by the compensation signal (V₃₀₀), thereby controlling an electric current supplied to the servomotor; and

rigidity-change compensation unit composed of a ball screw expansion/contraction amount calculating section for calculating an expansion or contraction amount (st) of a screw section of the ball screw, a spring rigidity calculating section for calculating a value of spring rigidity (K_{L}) along an axial direction of the ball screw from the calculated expansion or contraction amount (st) of the screw section, and a spring rigidity setting section for setting the calculated value of spring rigidity (K_{L}) as a value of spring rigidity (K_{L}) included in computing equations of the compensating transfer functions.

Another constitution of the present invention is the above servo control apparatus, wherein

the ball screw expansion/contraction amount calculating section of the rigidity-change compensation unit calculates the expansion or contraction amount (st) of the screw section based on the load position signal (θ_{L}) and a motor position signal (θ_{M}) indicating a rotational position of the servomotor.

Still another constitution of the present invention is the above servo control apparatus, wherein

the ball screw expansion/contraction amount calculating section of the rigidity-change compensation unit calculates the expansion or contraction amount (st)) of the screw section by applying a temperature of the screw section of the ball screw to relation characteristics showing a relation between the temperature of the screw section and the expansion or contraction amount of the screw section.

A further constitution of the present invention is the above servo control apparatus, wherein

the ball screw expansion/contraction amount calculating section of the rigidity-change compensation unit calculates the expansion or contraction amount (st) of the screw section based on a displacement of the screw section of the ball screw.

A still further constitution of the present invention is the above servo control apparatus, wherein

the spring rigidity calculating section of the rigidity-change compensation unit

has a plurality of relation characteristics showing a relation between the position of the load and the spring rigidity (K_{L}) in accordance with the expansion or contraction amount (st) of the screw section, and

calculates the spring rigidity (K_{L}) by selecting from among the plurality of relation characteristics the relation characteristics conformed to the expansion or contraction amount (st) of the screw section calculated by the ball screw expansion/contraction amount calculating section, and applying the position of the load indicated by the load position signal (θ_{L}) to the selected relation characteristics.

An additional constitution of the present invention is the above servo control apparatus, wherein

the spring rigidity calculating section of the rigidity-change compensation unit

has a plurality of computing equations for obtaining the spring rigidity (K_{L}) in accordance with the expansion or contraction amount (st) of the screw section, and

calculates the spring rigidity (K_{L}) by selecting from among the plurality of computing equations the computing equation conformed to the expansion or contraction amount (st) of the screw section calculated by the ball screw expansion/contraction amount calculating section, and using the selected computing equation.

### Effects of the Invention

According to the present invention, the servo control apparatus controls an industrial machine in which a rotational movement of a servomotor is converted into a linear movement by a feeding mechanism, including a ball screw, to move a load linearly by the converted linear movement. Even when the ball screw of the feeding mechanism expands or contracts because of a secular change or temperature change and the rigidity along the axial direction of the ball screw changes, the servo control apparatus can compensate for such changes in rigidity and perform accurate servo control of the position of the load.

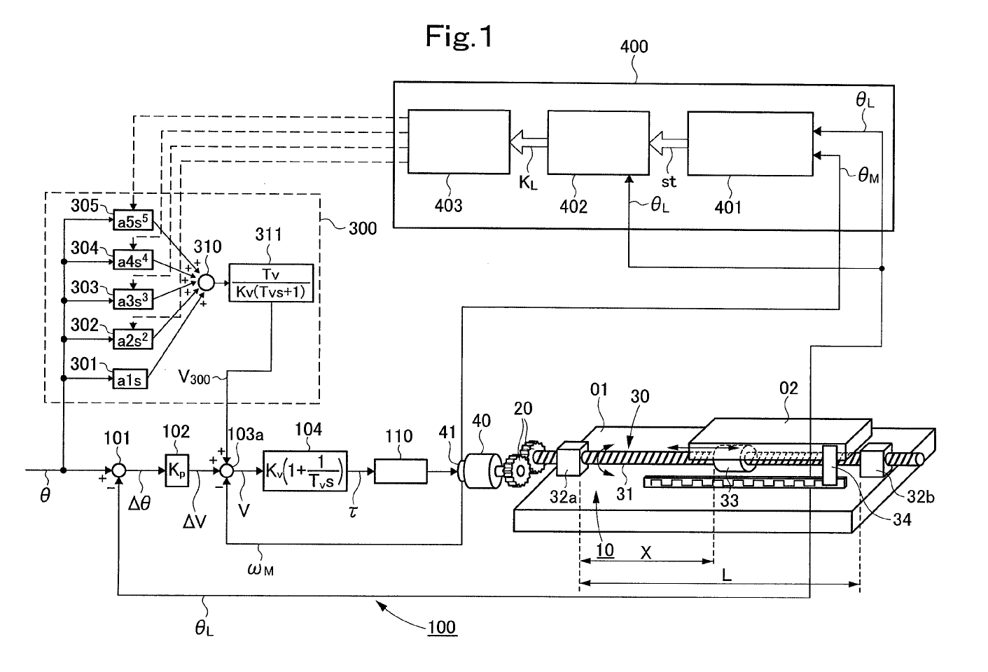

### BRIEF DESCRIPTION OF THE DRAWINGS

[FIG. 1] is a configurational drawing showing a servo control apparatus according to an embodiment of the present invention.

[FIG. 2] is a perspective view showing an example of a machine tool.

[FIG. 3] is a configurational drawing showing a feeding mechanism.

[FIG. 4] is a configurational drawing showing a feedback control circuit.

[FIG. 5] is a configurational drawing showing a circuit incorporating a feedforward control circuit.

[FIG. 6] is a configurational drawing showing a circuit incorporating an inverse characteristic model.

[FIG. 7(a)] is a characteristic view showing the relation between the load position and the spring rigidity of a ball screw when the amount of expansion or contraction of a screw section is small.

[FIG. 7(b)] is a characteristic view showing the relation between the load position and the spring rigidity of the ball screw when the amount of expansion or contraction of the screw section is medium.

[FIG. 7(c)] is a characteristic view showing the relation between the load position and the spring rigidity of the ball screw when the amount of expansion or contraction of the screw section is great.

### MODE FOR CARRYING OUT THE INVENTION

Modes for carrying out the present invention will be described in detail based on an embodiment.

Parts which perform the same functions as in the conventional technologies will be assigned the same numerals or symbols as in the conventional technologies, and explanations for the same parts will be simplified.

### Embodiment

### Explanation for Overall Constitution of Embodiment

FIG. 1 shows a servo control apparatus according to an embodiment of the present invention.

This embodiment is an embodiment in which the present invention is applied to a feeding mechanism 10 for driving a table 02 of a machine tool. That is, when a servomotor 40 rotates, its rotating force is transmitted to a screw section 31 of a ball screw 30 via a speed reducer 20, whereby the screw section 31 rotates. When the screw section 31 supported by rotating support brackets 32a, 32b rotates, a nut section 33 linearly moves along the screw section 31, and the table 02 linearly moves in accordance with the linear movement of the nut section 33.

The rotating support bracket 32a is disposed to pull the screw section 31 toward the base end (leftward in FIG. 1), thereby exerting a tensile force on the screw section 31.

At this time, the rotational position of the servomotor 40 can be detected based on a motor position signal θ_{M} which is a signal (pulse signal) outputted from a pulse encoder 41 disposed on the servomotor 40.

The linear movement position of the table 02 can be detected based on a load position signal θ_{L} outputted from a position detector 34 such as a linear scale.

Control means has a control unit 100 for performing feedback control, an inverse characteristic model 300 for performing feedforward compensation control, and a rigidity-change compensation unit 400 for setting and changing the coefficient value of the inverse characteristic model.

### Explanation for Control Unit

The control unit 100 has the same configuration as that of the control unit 100 shown in FIG. 6, and performs the same control actions as does the control unit 100 of FIG. 6. That is, a subtracter 101 of the control unit 100 outputs a position error signal Δθ which is the difference between a position command signal θ and the load position signal θ_{L}. A multiplier 102 multiplies the position error signal Δθ by a position loop gain Kₚ to output a speed error signal ΔV.

A subtracter 103a adds a speed compensation signal V₃₀₀, which has been outputted from the inverse characteristic model 300, to the speed error signal ΔV, and subtracts a motor speed signal ω_{M} from the resulting sum to output a speed command signal V.

A proportional plus integral computing unit 104 performs the proportional plus integral computation of the speed command signal V to output a torque command signal τ.

A current controller 110 supplies the servomotor 40 with an electric current conformed to the torque command signal τ.

### Explanation for Inverse Characteristic Model

The basic configuration and actions of the inverse characteristic model 300 are the same as those of the inverse characteristic model 300 shown in FIG. 6.

The inverse characteristic model 300 has a first-order derivative term computing unit 301, a second-order derivative term computing unit 302, a third-order derivative term computing unit 303, a fourth-order derivative term computing unit 304, a fifth-order derivative term computing unit 305, a summing unit 310, and a proportional plus integral inverse transfer function unit 311.

That is, compensation control transfer functions, which compensate for sources of error, are set in the inverse characteristic model 300 by computing equations established in the respective derivative term computing units 301 to 305, the summing unit 310, and the proportional plus integral inverse transfer function unit 311.

The compensation control transfer functions, adapted to perform compensation control for compensating for causes of dynamic error in the servomotor 40, sources of dynamic error in the feeding mechanism 10, and sources of dynamic error in the table 02 as the load to bring the position indicated by the load position signal θ_{L} into conformity with the position indicated by the position command signal θ, are set in the respective derivative term computing units 301 to 305 and the summing unit 310.

The compensation control transfer functions are inverse transfer functions which are the reverse of the transfer functions of the mechanical system composed of the servomotor 40, the feeding mechanism 10 and the table (load) 02. These inverse transfer functions are functions from which some arithmetic elements have been omitted.

Concretely, the first-order to fifth-order derivative term computing units 301 to 305 have operands a1s, a2s², a3s³, a4s⁴ and a5s⁵, respectively, and output arithmetic signals obtained by multiplying the position command signal θ by the respective operands. The symbol “s” represents a Laplace operator (differential operator).

In this case, the values of the coefficients a1 to a5 are set as indicated below, provided that

K_{V} is the speed loop gain,

K_{L} is the spring rigidity along the axial direction of the ball screw 30,

T_{V} is the integration time constant,

D_{M} is the viscosity of the servomotor 40,

D_{L} is the viscosity of the load (table 02),

J_{M} is the inertia of the servomotor 40, and

J_{L} is the inertia of the load (table 02).

$$a 1 = \frac{{K}_{V}}{{T}_{V}} \\ a 2 = {D}_{M} + {D}_{L} + {K}_{V} + \frac{{K}_{V} {D}_{L}}{{T}_{V} {K}_{L}} \\ a 3 = {J}_{M} + {J}_{L} + \frac{{D}_{M} {D}_{L} + {K}_{V} {D}_{L}}{{K}_{L}} + \frac{{K}_{V} {J}_{L}}{{T}_{V} {K}_{L}} \\ a 4 = \frac{{J}_{M} {D}_{L} + {J}_{L} {D}_{M} + {K}_{V} {J}_{L}}{{K}_{L}} \\ a 5 = \frac{{J}_{M} {J}_{L}}{{K}_{L}} \qquad [ Equation 2 ]$$

The proportional plus integral inverse transfer function unit 311 has, as its transfer function, {Tᵥ/Kᵥ(Tᵥₛ+1)} of {Tᵥ/Kᵥ(Tᵥₛ+1)}×s which is an inverse transfer function for Kᵥ(1+(1/Tᵥₛ)) being the transfer function of the proportional plus integral computing unit 104. The differential operator s is allocated to the respective coefficients a1 to a5.

The transfer function {Tᵥ/Kᵥ(Tᵥₛ+1)} set in the proportional plus integral inverse transfer function unit 311 is a fixed value (constant value) determined by the characteristics of the control system.

Furthermore, the value of the spring rigidity K_{L} along the axial direction of the ball screw 30, which is included in the coefficients a2 to a5, has been set upon calculation by the rigidity-change compensation unit 400 in accordance with the expansion or contraction of the screw section 31 of the ball screw 30.

So changing the value of the spring rigidity K_{L} in accordance with the expansion or contraction of the screw section 31 of the ball screw 30 is the characteristic technology of the present embodiment.

### Explanation for Rigidity-Change Compensation Unit

The rigidity-change compensation unit 400 is composed of a ball screw expansion/contraction amount calculating section 401, a spring rigidity calculating section 402, and a spring rigidity setting section 403.

The ball screw expansion/contraction amount calculating section 401 calculates the expansion or contraction amount st of the screw section 31 of the ball screw 30.

Concretely, the ball screw expansion/contraction amount calculating section 401 obtains a deviation between the load position signal θ_{L} and a position-converted signal which is a load position signal converted from the motor position signal θ_{M}and determines the expansion or contraction amount st of the screw section 31 based on this deviation.

As techniques for determining the expansion or contraction amount st of the screw section 31, the following two other methods can be adopted:

With the first of the other methods, the screw section 31 is provided with a temperature detecting sensor. Relation characteristics showing the relation between the temperature of the screw section 31 and the amount of expansion or contraction of the screw section 31 are set beforehand in the ball screw expansion/contraction amount calculating section 401. A detection temperature detected by the temperature detecting sensor is applied to the relation characteristics to determine the expansion or contraction amount st of the screw section 31.

With the second of the other methods, the screw section 31 is provided with a displacement detecting sensor. The ball screw expansion/contraction amount calculating section 401 obtains the expansion or contraction amount st of the screw section 31 from the amount of displacement detected by the displacement detecting sensor.

The spring rigidity calculating section 402 calculates the spring rigidity K_{L} along the axial direction of the ball screw 30 with the use of the expansion or contraction amount st of the screw section 31 of the ball screw 30 and the load position signal θ_{L} indicating the position of the table 02 as the load.

Concretely, the plurality of relation characteristics shown in FIGS. 7(a), 7(b) and 7(c), which represent the relation between the load position and the spring rigidity KL in accordance with the value (whether large or small) of the expansion or contraction amount st of the screw sectional, are set beforehand in the spring rigidity calculating section 402.

FIG. 7(a) shows the spring rigidity K_{L} conformed to the load position when the expansion or contraction amount st of the screw section 31 is small. That is, FIG. 7(a) shows the spring rigidity K_{L} conformed to the load position when the screw section 31 is reliably pulled by the support bracket 32b and the screw section 31 is firmly supported by the support bracket 32a and the support bracket 32b (both ends are fixedly supported).

FIG. 7(b) shows the spring rigidity K_{L} conformed to the load position when the expansion or contraction amount st of the screw section 31 is medium. That is, FIG. 7(b) shows the spring rigidity K_{L} conformed to the load position when the screw section 31 is somewhat expanded in the axial direction because of a temperature change or the like, and the screw section 31 is firmly supported at the support bracket 32a (fixedly supported at one end), but the support for it at the support bracket 32b slackens (semi-fixedly supported at the other end).

FIG. 7(c) shows the spring rigidity K_{L} conformed to the load position when the expansion or contraction amount st of the screw section 31 is great. That is, FIG. 7(c) shows the spring rigidity K_{L} conformed to the load position when the screw section 31 is greatly expanded in the axial direction because of a temperature change or the like, and the screw section 31 is firmly supported at the support bracket 32a (fixedly supported at one end), but the support for it at the support bracket 32b completely slackens (freed at the other end).

Furthermore, the spring rigidity calculating section 402 classifies the expansion or contraction amount st, which has been calculated by the ball screw expansion/contraction amount calculating section 401, as “small”, “medium” or “large” according to its value (whether it is large or small). This classification is made by comparing the value with preset threshold values.

When the expansion or contraction amount st is “small”, the relation characteristics shown in FIG. 7(a) are selected. By applying the load position indicated by the load position signal θ_{L} to the selected relation characteristics, the spring rigidity K_{L} is determined.

When the expansion or contraction amount st is “medium”, the relation characteristics shown in FIG. 7(b) are selected. By applying the load position indicated by the load position signal θ_{L} to the selected relation characteristics, the spring rigidity K_{L} is determined.

When the expansion or contraction amount st is “large”, the relation characteristics shown in FIG. 7(c) are selected. By applying the load position indicated by the load position signal θ_{L} to the selected relation characteristics, the spring rigidity K_{L} is determined.

By thus making the relation characteristics used different according to the value (small, medium or large) of the expansion or contraction amount st of the screw section 31, the accurate spring rigidity K_{L} conformed to the state of expansion or contract can be obtained, even if the screw section 31 expands or contracts owing to a secular change or temperature change.

As a technique for obtaining the accurate spring rigidity K_{L} conformed to the state of expansion or contraction of the screw section 31, there can be employed an alternative method as described below in which a plurality of spring rigidity computing equations are set beforehand.

According to this alternative method for obtaining accurate spring rigidity K_{L} conformed to the state of expansion or contraction of the screw section 31, the expansion or contraction amount st calculated by the ball screw expansion/contraction amount calculating section 401 is classified as “small”, “medium” or “large” according to its value (whether it is large or small). This classification is made by comparing the value with preset threshold values.

In accordance with the value (small, medium, large) of the expansion or contraction amount st of the screw section 31, computations indicated below are performed to obtain accurate spring rigidity K_{L} conformed to the state of expansion or contraction, provided that

A is the sectional area [m²] of the screw section 31,

dr is the diameter [m] of the root of the thread of the screw section 31,

E is the modulus of longitudinal elasticity [N/m²] of the screw section 31,

X is the distance [m] of the action point of the load, namely, the distance between the support bracket 32a and the nut section 33 as shown in FIG. 1,

L is the mounting distance [m], namely, the distance between the support brackets 32a and 32b as shown in FIG. 1, and k is the coefficient (0.0 to 1.0) which is varied according to the value of the expansion or contraction amount st.

When the expansion or contraction amount st of the screw section 31 is “small”, a computation by the following preset equation is carried out to obtain the spring rigidity K_{L} [N/m]:

K_{L}=(A·E·L)/{X·(L−X)}

When the expansion or contraction amount st of the screw section 31 is “medium”, a computation by the following preset equation is carried out to obtain the spring rigidity K_{L} [N/m]:

K_{L}=k{(A·E)/X}+(1−k)[(A·E·L)/{X·(L−X)}]

When the expansion or contraction amount st of the screw section 31 is “large”, a computation by the following preset equation is carried out to obtain the spring rigidity K_{L} [N/m]:

K_{L}=(A·E)/X

The operands a2s², a3s³, a4s⁴ and a5s⁵ are set in the second-order to fifth-order derivative term computing units 302 to 305 of the inverse characteristic model 300, and the spring rigidity K_{L} is included in the computing equations for obtaining their coefficients a2 to a5, as stated above.

Thus, the spring rigidity setting unit 403 sets the value of the spring rigidity K_{L}, which has been calculated by the spring rigidity calculating unit 402, as the value of the spring rigidity K_{L} which is included in the computing equations for obtaining the coefficients a2 to a5.

Even if the screw section 31 of the ball screw 30 expands or contracts owing to a secular change, temperature change or the like, whereby the value of the spring rigidity K_{L} along the axial direction of the ball screw 30 varies, therefore, the computations in the derivative term computing units 302 to 305 are performed using the varied value of the spring rigidity K_{L}.

As a result, the speed compensation signal V₃₀₀ computed by the inverse characteristic model 300 takes the optimum value, even if the screw section 31 expands or contracts owing to a secular change, temperature change or the like.

As described above, even if the screw section 31 expands or contracts owing to a secular change, temperature change or the like, the speed compensation signal V₃₀₀ takes the optimum value. Thus, compensation control can be effected so as to compensate for causes of dynamic error in the servomotor 40, sources of dynamic error in the feeding mechanism 10, and sources of dynamic error in the table 02 as the load to bring the position indicated by the load position signal θ_{L} into conformity with the position indicated by the position command signal θ with high accuracy.

The computing equations in the inverse characteristic model 300 change according to what mechanical system model the mechanical system (motor, table, or feeding mechanism) should be specified as, or according to how much the computing equations will be simplified. Even in such a case, the value of the spring rigidity K_{L} included in the computing equations of the inverse characteristic model 300 is set at the value of the spring rigidity K_{L} calculated by the spring rigidity calculating unit 402.

By so doing, even if the screw section 31 expands or contracts owing to a secular change, temperature change or the like, the speed compensation signal V₃₀₀ takes the optimum value. Thus, compensation control can be effected so as to compensate for causes of dynamic error in the servomotor 40, sources of dynamic error in the feeding mechanism 10, and sources of dynamic error in the table 02 as the load to bring the position indicated by the load position signal θ_{L} into conformity with the position indicated by the position command signal θ with high accuracy.

### INDUSTRIAL APPLICABILITY

The present invention can be applied not only to machine tools, but also to various industrial machines in which the rotational movement of a servomotor is converted into a linear movement by a ball screw to move a load linearly.

### DESCRIPTION OF THE NUMERALS

01 Bed

02 Table

03 Column

04 Cross rail

05 Saddle

06 Ram

10 Feeding mechanism

20 Speed reducer

30 Ball screw

31 Screw section

32a, 32b Rotating support bracket

33 Nut section

34 Position detector

40 Servomotor

41 Pulse encoder

100 Control unit

110 Current control unit

300 Inverse characteristic model

400 Rigidity change compensation unit

401 Ball screw expansion/contraction amount calculating section

402 Spring rigidity calculating section

403 Spring rigidity setting section

1. A servo control apparatus for controlling an industrial machine in which a rotational movement of a servomotor is converted into a linear movement by a feeding mechanism, including a ball screw, to move a load linearly by the converted linear movement, comprising:
an inverse characteristic model having, set therein, compensating transfer functions which are inverse transfer functions as a reverse of transfer functions of a mechanical system composed of the servomotor, the feeding mechanism, and the load, wherein the inverse characteristic model outputs a compensation signal (V₃₀₀) for compensating for sources of dynamic error of the mechanical system when a position command signal (θ) indicating a command position of the load is inputted to the compensating transfer functions;
a control unit for performing feedback control so as to eliminate a position error signal (Δθ) which is a deviation between the position command signal (θ) and a load position signal (θ_{L}) indicating a position of the load, and to eliminate a deviation between a speed error signal (ΔV) proportional to the position error signal (Δθ) and a motor speed signal (ω_{M}) indicating a speed of the servomotor, and for further performing feedforward compensation control by the compensation signal (V₃₀₀), thereby controlling an electric current supplied to the servomotor; and
rigidity-change compensation unit composed of a ball screw expansion/contraction amount calculating section for calculating an expansion or contraction amount (st) of a screw section of the ball screw, a spring rigidity calculating section for calculating a value of spring rigidity (K_{L}) along an axial direction of the ball screw from the calculated expansion or contraction amount (st) of the screw section, and a spring rigidity setting section for setting the calculated value of spring rigidity (K_{L}) as a value of spring rigidity (K_{L}) included in computing equations of the compensating transfer functions.

2. The servo control apparatus according to claim 1, wherein
the ball screw expansion/contraction amount calculating section of the rigidity-change compensation unit calculates the expansion or contraction amount (st) of the screw section based on the load position signal (θ_{L}) and a motor position signal (θ_{M}) indicating a rotational position of the servomotor.

3. The servo control apparatus according to claim 1, wherein
the ball screw expansion/contraction amount calculating section of the rigidity-change compensation unit calculates the expansion or contraction amount (st) of the screw section by applying a temperature of the screw section of the ball screw to relation characteristics showing a relation between the temperature of the screw section and the expansion or contraction amount of the screw section.

4. The servo control apparatus according to claim 1, wherein
the ball screw expansion/contraction amount calculating section of the rigidity-change compensation unit calculates the expansion or contraction amount (st) of the screw section based on a displacement of the screw section of the ball screw.

5. The servo control apparatus according to claim 1, wherein
the spring rigidity calculating section of the rigidity-change compensation unit
has a plurality of relation characteristics showing a relation between the position of the load and the spring rigidity (K_{L}) in accordance with the expansion or contraction amount (st) of the screw section, and
calculates the spring rigidity (K_{L}) by selecting from among the plurality of relation characteristics the relation characteristics conformed to the expansion or contraction amount (st) of the screw section calculated by the ball screw expansion/contraction amount calculating section, and applying the position of the load indicated by the load position signal coo to the selected relation characteristics.

6. The servo control apparatus according to claim 1, wherein
the spring rigidity calculating section of the rigidity-change compensation unit
has a plurality of computing equations for obtaining the spring rigidity (K_{L}) in accordance with the expansion or contraction amount (st) of the screw section, and
calculates the spring rigidity (K_{L}) by selecting from among the plurality of computing equations the computing equation conformed to the expansion or contraction amount (st) of the screw section calculated by the ball screw expansion/contraction amount calculating section, and using the selected computing equation.
